(19) United States
(12) Patent Application Publication
(10) Pub. No.: US 2013/0029577 A1
(43) Pub. Date: Jan. 31, 2013

(54) AIR VENT FOR VEHICLE

(71) Applicant: Sung Hwa Kim, Cheonan-si (KR)

(72) Inventor: Sung Hwa Kim, Cheonan-si (KR)

(73) Assignee: NIFCO KOREA INC., Cheonan-si, Chungcheongnam-do, (KR)

(21) Appl. No.: 13/520,950

(22) PCT Filed: Jan. 6, 2011
(86) PCT No.: PCT/KR11/00061

§ 371 Date: Aug. 27, 2012

(30) Foreign Application Priority Data
Jan. 8, 2010 (KR) 10-2010-0001736

(51) Int. Cl. B60H 1/24

(52) U.S. Cl. 454/155

(57) ABSTRACT

In an air vent for a vehicle according to the present invention including a vertical vane assembly connected to an air discharge port of a duct housing such that many vertical vanes can rotate together in a horizontal direction, an extending section is provided on one side of the air discharge port of the duct housing, and the vertical vane located on the side of the extending section among the vertical vanes of the vertical vane assembly is provided with an interlocking vane that adjusts the wind direction of air discharged to the extending section. The air vent for a vehicle can satisfy wind direction and wind volume while complying with the design of the duct housing and the air discharge port. By coupling the interlocking vane to the vertical vane located on the side of the extending section among the vertical vanes of the vertical vane assembly, and allowing the interlocking vane to be operable together with the other vertical vanes, it is possible to obtain the effect of improving its appearance without adversely affecting the wind direction.

### FIELD OF THE INVENTION

The present invention relates to an air vent for a vehicle, that guides external air to the inside of a vehicle, and in particular, an air vent for vehicle capable of satisfying wind direction and wind volume while complying with design of a duct housing and an air discharge port.

### BACKGROUND ART

An air vent for a vehicle according to the present invention can guide external air to the inside of the vehicle.

FIG. 1 is a front view of the air vent for a vehicle according to the present invention.

The present invention relates, as shown in FIG. 1, an air vent for a vehicle 100′ in which a vertical vane assembly 120′ that can adjust a horizontal discharge direction of air discharged to the inside of the vehicle and a horizontal vane assembly 130′ that can adjust a vertical discharge direction of the air discharged to the inside of the vehicle are installed in an air discharge port 111′ of a duct housing 110′.

FIG. 2 is an assembled front view of a duct housing and a vertical vane assembly of a conventional air vent for a vehicle, FIG. 3 is an exploded front view of the duct housing and the vertical vane assembly of the conventional air vent for a vehicle, FIG. 4a is a sectional view of a main section of the vertical vane assembly of the conventional air vent for a vehicle in a central discharge state, and FIG. 4b is a sectional view of the main section of the vertical vane assembly of the conventional air vent for the vehicle in a rightward discharge state.

As shown in FIG. 2 to FIG. 4b, in the conventional air vent for a vehicle 100′, to satisfy the wind direction while complying with the design of diamond-shaped duct housing 110′ having an oblique left side and an oblique right side, an upper left section of the air discharge port 111′ is sealed. For this reason, an air discharge area becomes small, resulting in decrease in the wind volume and increase in the flow rate, possibly causing noises.

That is, as shown in FIG. 4b, in the conventional air vent for the vehicle 100′, a ratio of an area A′ where the wind direction cannot be adjusted to the inside of the duct housing 110′ becomes large, while an effective area B′ where the wind direction can be adjusted becomes smaller.

Due to the design of the diamond-shaped duct housing 110′, arrangement of vertical vanes 121′ of the vertical vane assembly 120′ is unnatural, which is poor in appearance. When a separate non-driven fixed vane 122′ is installed in the upper left section of the sealed air discharge port 111′ to resolve such unnaturalness, the wind direction is adversely affected.

### SUMMARY OF THE INVENTION

### Problem to be Solved by the Invention

The present invention is made in consideration with such conventional circumstances, and an object is to provide an air vent for a vehicle capable of satisfying wind direction and wind volume while complying with the design of a duct housing and an air discharge port.

Another object of the present invention is to provide an air vent for a vehicle capable of driving vertical vanes of a vertical vane assembly and an interlocking vane as well as improving its appearance.

### Means for Solving the Problems

To attain the above-mentioned object, in an air vent for a vehicle according to the present invention, an extending section is provided on one side of an air discharge port of a duct housing, and a vertical vane located on the side of the extending section among vertical vanes of a vertical vane assembly is provided with an interlocking vane that adjusts the wind direction of air discharged to the extending section.

That is, according to the present invention, in an air vent for a vehicle including a vertical vane assembly connected to an air discharge port of a duct housing such that a lot of vertical vanes can rotate together in a horizontal direction, an extending section is provided on one side of the air discharge port of the duct housing, and the vertical vane located on the side of the extending section among the vertical vanes of the vertical vane assembly is provided with an interlocking vane that adjusts the wind direction of air discharged to the extending section.

According to the present invention, the interlocking vane is coupled to the vertical vane located on the side of the extending section among the vertical vanes of the vertical vane assembly via coupling pieces integrally formed at an upper end and a lower end of the right side surface of the vertical vane.

A width of the interlocking vane is set to fall within a circle having its center as a rotational center of the vertical vane located on the side of the extending section and a radius as a distance between the center and an inner wall of the duct housing.

### Effect of the Invention

When the extending section is provided on one side of the air discharge port of the duct housing as in the air vent for a vehicle according to the present invention, the wind direction and the wind volume can be satisfied while complying with the design of the duct housing and the air discharge port. Further, by coupling the interlocking vane to the vertical vane located on the side of the extending section among the vertical vanes of the vertical vane assembly, and allowing the interlocking vane to be operable together with the other vertical vanes, it is possible to obtain the effect of improving its appearance without adversely affecting the wind direction.

### BRIEF DESCRIPTION OF THE DRAWINGS

FIG. 1 is a front view of an air vent for a vehicle according to the present invention.

FIG. 2 is an assembled front view of a duct housing and a vertical vane assembly of a conventional air vent for vehicle.

FIG. 3 is an exploded front view of the duct housing and the vertical vane assembly of the conventional air vent for a vehicle.

FIG. 4a is a sectional view of a main section of the vertical vane assembly of the conventional air vent for a vehicle in a central discharge state.

FIG. 4b is a sectional view of the main section of the vertical vane assembly of the conventional air vent for a vehicle in a rightward discharge state.

FIG. 5 is an assembled front view of a duct housing and a vertical vane assembly in accordance with one embodiment of the present invention.

FIG. 6 is an exploded front view of the duct housing and the vertical vane assembly in accordance with one embodiment of the present invention.

FIG. 7a is a sectional view of a main section of the vertical vane assembly of the air vent for a vehicle in a central discharge state in accordance with one embodiment of the present invention.

FIG. 7b is a sectional view of the main section of the vertical vane assembly of the air vent for a vehicle in a rightward discharge state in accordance with one embodiment of the present invention.

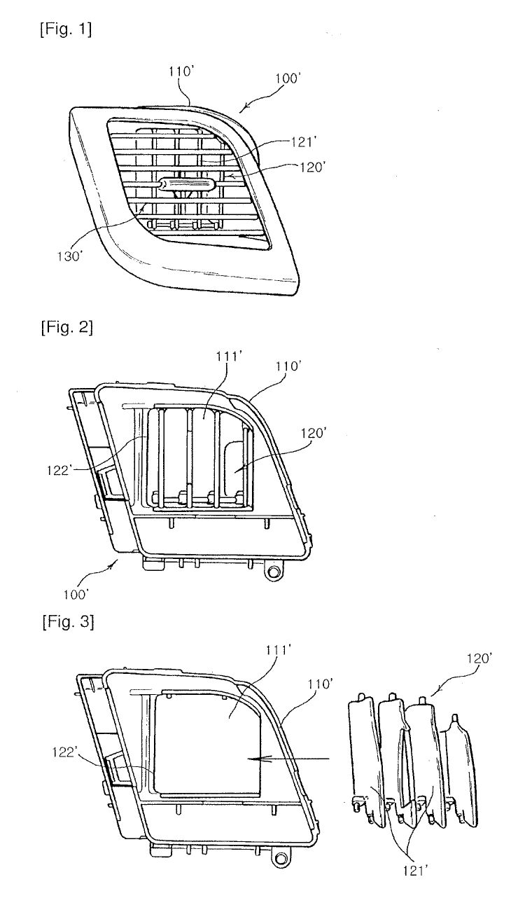

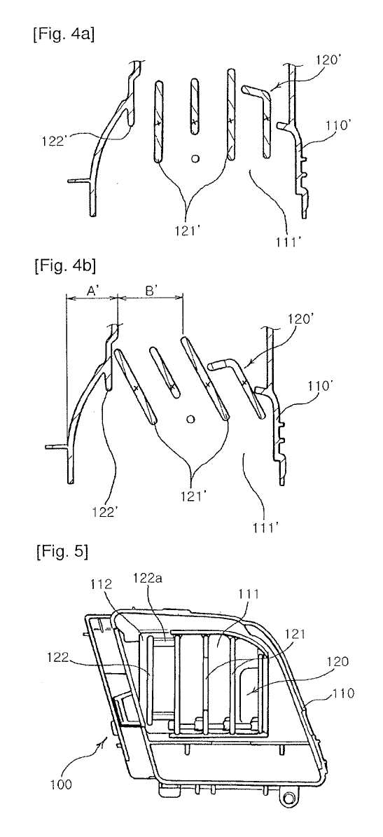

### BEST MODE FOR CARRYING OUT THE INVENTION

Specific technical concepts of the present invention will be described below in detail based on an embodiment shown in appended drawings.

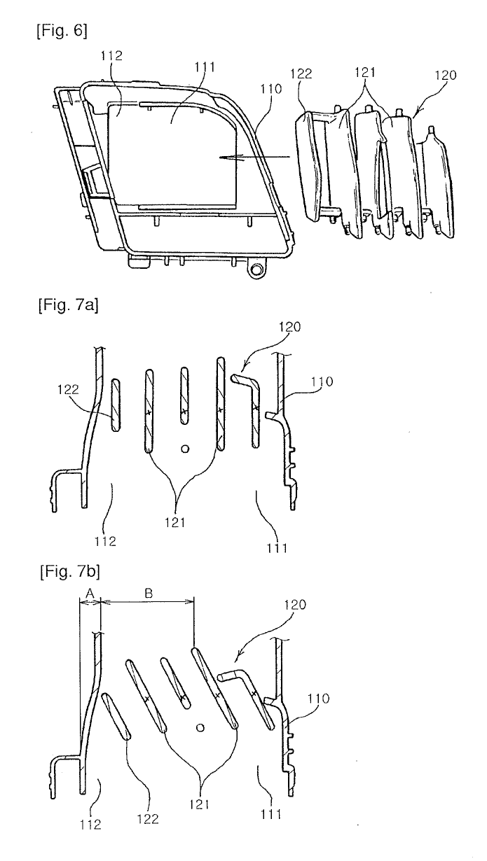

FIG. 5 is an assembled front view of a duct housing and a vertical vane assembly in accordance with one embodiment of the present invention, FIG. 6 is an exploded front view of the duct housing and the vertical vane assembly in accordance with one embodiment of the present invention, FIG. 7a is a sectional view of a main section of the vertical vane assembly of the air vent for a vehicle in a central discharge state in accordance with one embodiment of the present invention, and FIG. 7b is a sectional view of the main section of the vertical vane assembly of the air vent for a vehicle in a rightward discharge state in accordance with one embodiment of the present invention.

As shown in FIG. 5 to FIG. 7b, according to the present invention, in the air vent 100 for a vehicle, a vertical vane assembly 120 is connected to an air discharge port 111 of a duct housing 110 such that many vertical vanes 121 can rotate together in a horizontal direction. An extending section 112 is provided on one side of the air discharge port 111 of the duct housing 110, and the vertical vane 121 located on the side of the extending section 112 among the vertical vanes 121 of the vertical vane assembly 120 is provided with an interlocking vane 122 that adjusts the wind direction of air discharged to the extending section 112.

According to the present invention, a width of the interlocking vane 122 is set to fall within a circle having its center as a rotational center of the vertical vane 121 located on the side of the extending section 112 and a radius as a distance between the center and an inner wall of the duct housing 110.

In the illustrated embodiment, the interlocking vane 122 is coupled to the vertical vane 121 located on the side of the extending section 112 among the vertical vanes 121 of the vertical vane assembly 120 via a pair of coupling pieces 122a.

In the illustrated embodiment, the duct housing 110 has a diamond shape having an oblique left side and an oblique right side, and the extending section 112 is provided in an upper left section of the air discharge port 111. According to the present invention, the shape of the duct housing 110, the air discharge port 111 and the extending section 112 is not limited to that in the illustrated embodiment, and as a matter of course, may be modified.

An unexplained reference member 130′ among reference members in the figures refers to a knob.

In the air vent 100 for a vehicle thus configured according to the present invention, the interlocking vane 122 coupled to the vertical vane 121 located on the side of the extending section 112 among the vertical vanes 121 of the vertical vane assembly 120 is located in the extending section 112 provided on one side of the air discharge port 111 of the duct housing 110. When the vertical vanes 121 of the vertical vane assembly 120 are rotated leftward or rightward via the knob to adjust the wind direction, the interlocking vane 122 coupled to the vertical vane 121 located on the side of the extending section 112 among the vertical vanes 121 of the vertical vane assembly 120 is also rotated leftward or rightward, thereby adjusting the discharge direction of the air discharged toward the extending section 112 of the air discharge port 111.

In the air vent 100 for a vehicle according to the present invention, since the conventionally-sealed one side section of the air discharge port 111 of the duct housing 110 is extended and opened, as shown in FIG. 5b, a ratio of an area A′ where the wind direction cannot be adjusted to the inside of the duct housing becomes very small, resulting in that an effective area B where the wind direction can be adjusted becomes large.

It is apparent for those skilled in the art that the present invention described above is not limited by the above description, and may be variously replaced, modified and changed so as not to deviate from the technical concept of the present invention.

1. A air vent for a vehicle comprising a vertical vane assembly connected to an air discharge port of a duct housing such that many vertical vanes can rotate together in a horizontal direction, wherein an extending section is provided on one side of the air discharge port of the duct housing, and
the vertical vane located on the side of the extending section among the vertical vanes of the vertical vane assembly is provided with an interlocking vane that adjusts the wind direction of air discharged to the extending section.

2. The air vent for a vehicle according to claim 1, wherein the interlocking vane is coupled to the vertical vane located on the side of the extending section among the vertical vanes of the vertical vane assembly via a pair of coupling pieces.

3. The air vent for a vehicle according to claim 1, wherein a width of the interlocking vane is set to fall within a circle having its center as a rotational center of the vertical vane located on the side of the extending section and a radius as a distance between the center and an inner wall of the duct housing.
